(19) United States
(12) Patent Application Publication
(10) Pub. No.: US 2024/0280355 A1
(43) Pub. Date: Aug. 22, 2024

(54) JOINT BENDING ESTIMATION

(71) Applicant: Snap Inc., Santa Monica, CA (US)

(72) Inventors: Matthias Kalkgruber, Vienna (AT); Tiago Miguel Pereira Torres, Vienna (AT); Chao Chen, Marina Del Rey, CA (US); Jason Heger, Louisville, CO (US); John Recchio, Los Angeles, CA (US); Mark Kraz, Los Gatos, CA (US); Michael Ryner, Santa Monica, CA (US)

(21) Appl. No.: 18/172,874

(22) Filed: Feb. 22, 2023

(51) Int. Cl. G01B 5/30; G01L 1/22; G02B 27/01; G06T 19/00

(52) U.S. Cl. CPC G01B 5/30; G01L 1/2206; G02B 27/0176; G06T 19/006; G02B 2027/0178

(57) ABSTRACT

A system for correcting for frame bending of an augmented reality system is provided. A combination of strain gauges and visual inertial odometry is used to determine strains in the frame. An initial model between strain gauge measurements and actual frame spatial relationships is based on finite element analysis or calibration. During an initial visual inertial odometry data calculation phase, the augmented reality system calculates bending or strains of the frame using strain data from the strain gauges mounted to the frame. Subsequent visual inertial odometry data calculations are used to generate a corrected frame model of the frame. The corrected frame model is used for calculating corrected tracking data and corrected virtual overlays that are used to generate virtual overlays used in an AR experience provided by the augmented reality system.

### TECHNICAL FIELD

The present disclosure relates generally to user interfaces and more particularly to user interfaces used in augmented and virtual reality.

### BACKGROUND

A head-worn device may be implemented with a transparent or semi-transparent display through which a user of the head-worn device can view a surrounding environment or real-world scene. Such devices enable a user to see through the transparent or semi-transparent display to view the real-world scene, and to also see objects (e.g., virtual objects such as a rendering of a 2D or 3D graphic model, images, video, text, and so forth) that are generated for display to appear as a part of, and/or overlaid upon, the real-world scene. This is typically referred to as “augmented reality” or “AR.” A head-worn device may additionally completely occlude a user's visual field and display a virtual environment through which a user may move or be moved. This is typically referred to as “virtual reality” or “VR.” In a hybrid form, a view of the real-world scene is captured using imaging devices, and then that view is displayed along with augmentation to the user on displays that occlude the user's eyes. As used herein, the term AR refers to augmented reality, virtual reality and any of hybrids of these technologies unless the context indicates otherwise.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a perspective view of a head-worn device, in accordance with some examples.

FIG. 2 illustrates a further view of the head-worn device of FIG. 1, in accordance with some examples.

FIG. 3 is an illustration of forces and their effects on a frame of a head-worn AR apparatus, according to some examples.

FIG. 4A illustrates misalignment errors resulting from a yaw bending of a head-worn AR system in response of lateral forces acting on a frame of the head-worn AR system, according to some examples.

FIG. 4B illustrates a misalignment error caused by pitch movement of a head-worn AR system, according to some examples.

FIG. 5A is a flowchart of a frame bending correction method used by a head-worn AR system according to some examples.

FIG. 5B is a collaboration diagram of components of an AR system according to some examples.

FIG. 6 is a diagrammatic representation of a machine within which a set of instructions may be executed for causing the machine to perform any one or more of the methodologies discussed herein in accordance with some examples.

FIG. 7 is a block diagram illustrating a networked system including details of a head-worn AR system, in accordance with some examples.

FIG. 8 is a block diagram showing a software architecture within which the present disclosure may be implemented, in accordance with some examples.

FIG. 9 is a block diagram showing an example messaging system for exchanging data (e.g., messages and associated content) over a network in accordance with some examples.

### DETAILED DESCRIPTION

A user of the head-worn device is provided with virtual overlays of an AR experience as the user wears the head-worn device. By wearing the head-worn device, various forces act on the head-worn device causing strain and bending. Therefore, it is desirable to have a mechanism for generating virtual overlays corrected for the bending of the head-worn device.

Knowledge of spatial relationships of system components of a head-worn AR apparatus is useful for generating accurate virtual overlays for AR experiences. Ergonomic and visually appealing frame designs for a head-worn AR apparatus lead to lightweight glasses. However, such designs may be less rigid and this may lead to spatial relationships between different components of the head-worn AR apparatus, such as displays, imaging devices such as cameras of the like, inertial measurement units, and projectors, changing over time. Such relationships may also change during normal operation by a user simply putting on the head-worn AR apparatus, walking or touching a frame of the head-worn apparatus. This may result in incorrect sensing of the surrounding world (e.g., stereo-depth estimation) which leads to unrealistic AR experiences. Examples disclosed herein provide for coupling strain gauges with a Visual Inertial Odometry (VIO) system to measure changing spatial relations and provide improved AR experiences for flexible and ergonomic frame designs.

In some examples, a combination of strain gauge sensors with a VIO system includes defining a physical frame model of a frame of a head-worn AR apparatus that is part of an AR system. Correlations are determined between strain gauge measurements and actual frame spatial relationships based on finite element analysis or calibration. During use, the AR system seeds calculations of bending or strains of the frame during an initial VIO data calculation phase with strain data from strain gauges mounted to the frame. Subsequent VIO data calculations are used to generate a corrected frame model of the frame. The corrected frame model is used for calculating corrected tracking data and corrected virtual overlays that are used to generate virtual overlays used in an AR experience.

In some examples, inertial movement data is used to seed the VIO data generation process.

In some examples, the strain gauge data is used without the VIO data to provide a low-power option for generating corrected frame models.

In some examples, an AR system includes a frame and one or more strain gauges operable to measure strains of the frame. The AR system also includes one or more imaging devices mounted to the frame. During operation, the AR system measures tracking video frame data of a real-world scene being viewed by a user of the AR system. The AR system also measures strain data of the strains of the frame of the AR system as the tracking video frame data is being captured, The AR system generates a corrected frame model of the frame based on the strain data, the tracking video frame data, and a frame model of the frame. The AR system uses the corrected frame model and the tracking video frame data to generate corrected tracking data. The corrected tracking data is used to generate a virtual overlay and the virtual overlay is rendered for display by an optical engine using the corrected frame model.

Other technical features may be readily apparent to one skilled in the art from the following figures, descriptions, and claims.

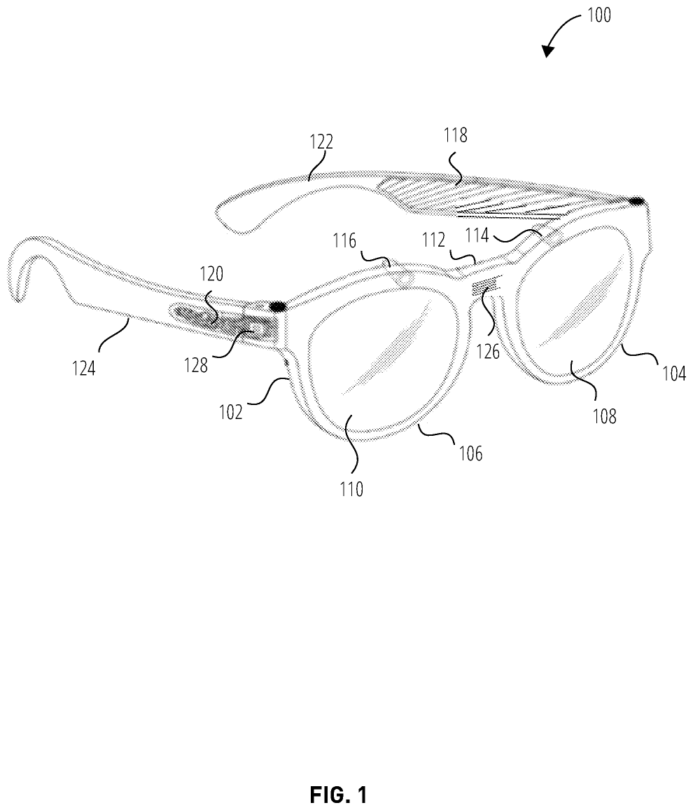

FIG. 1 is a perspective view of a head-worn AR system (e.g., head-worn AR apparatus 100 of FIG. 1), in accordance with some examples.

As used herein, directional terms such as, but not limited to, “up”, “upper”, “down”, “lower”, “vertical”, “horizontal”, “lateral”, “left”, “right”, “forward”, and “backward” are to be interpreted from a perspective of a user wearing a head-worn AR system such as head-worn AR apparatus 100 unless an alternative meaning is indicated.

The head-worn AR apparatus 100 can include a frame 102 made from any suitable material such as plastic or metal, including any suitable shape memory alloy. In one or more examples, the frame 102 includes a first or left optical element holder 104 (e.g., a display or lens holder) and a second or right optical element holder 106 connected by a bridge portion 112. A first or left optical element 108 and a second or right optical element 110 can be provided within respective left optical element holder 104 and right optical element holder 106. The right optical element 110 and the left optical element 108 can be a lens, a display, a display assembly, or a combination of the foregoing. Any suitable display assembly can be provided in the head-worn AR apparatus 100.

The frame 102 additionally includes a left arm or left temple piece 122 and a right arm or right temple piece 124. In some examples the frame 102 can be formed from a single piece of material so as to have a unitary or integral construction.

The head-worn AR apparatus 100 can include a computing system, such as a computer 120, which can be of any suitable type so as to be carried by the frame 102 and, in one or more examples, of a suitable size and shape, so as to be partially disposed in one of the left temple piece 122 or the right temple piece 124. The computer 120 can include multiple processors, memory, and various communication components sharing a common power source. As discussed below, various components of the computer 120 may comprise low-power circuitry, high-speed circuitry, and a display processor. Various other examples may include these elements in different configurations or integrated together in different ways. Additional details of aspects of the computer 120 may be implemented as illustrated by the data processor 702 discussed below.

The computer 120 additionally includes a battery 118 or other suitable portable power supply. In some examples, the battery 118 is disposed in a left temple piece 122 and is electrically coupled to the computer 120 disposed in the right temple piece 124. In some examples, the battery 118 comprises two separate components, each disposed in a respective temple piece. The head-worn AR apparatus 100 can include a connector or port (not shown) suitable for charging the battery 118, a wireless receiver, transmitter or transceiver (not shown), or a combination of such devices.

The head-worn AR apparatus 100 include a first or left imaging device 114 and a second or right imaging device 116. In some examples, one or more imaging devices of the head-worn AR apparatus 100 comprise an imaging sensor and an optics assembly, such as, but not limited to a camera or the like. In some examples, the imaging sensor senses electromagnetic radiation in the visible light spectrum. In some examples, the imaging sensor senses electromagnetic radiation in the infrared spectrum.

In some examples, the head-worn AR apparatus 100 further include one or more light emitting sources, such as Light Emitting Diodes (LEDs). In some examples, one or more LEDs of the AR system operate in the infrared range of light frequencies. In some examples, the one or more light emitting sources emit diffused light. In some examples, the one or more light emitting sources project light in a specified pattern.

In some examples, one or more imaging devices of the head-worn AR apparatus 100 include one or more Laser Imaging, Detection, and Ranging (LIDAR) devices.

Although two imaging devices are depicted, other examples contemplate the use of a single or additional (i.e., more than two) imaging devices. In one or more examples, the head-worn AR apparatus 100 include any number of input sensors or other input/output devices in addition to the left imaging device 114 and the right imaging device 116. Such sensors or input/output devices can additionally include biometric sensors, location sensors, motion sensors, and so forth.

In some examples, the left imaging device 114 and the right imaging device 116 provide video frame data for use by the head-worn AR apparatus 100 to extract 3D information from a real-world scene.

One or more strain gauges 126 are attached to the frame 102 at a bridge portion 112 of the frame. The one or more strain gauges 126 are operable to measure horizontal or longitudinal strains of the frame 102. In some examples, the one or more strain gauges 126 are configured to measure vertical or latitudinal strains of the frame 102. In some examples, the one or more strain gauges 126 is configured to measure torsional strains of the frame 102. In some examples, one or more of the strain gauges 126 are located on other portions of the frame 102 such as, but not limited to, a portion of the right optical element holder 106, or a portion of the left optical element holder 104.

The head-worn AR apparatus 100 may also include a touchpad mounted to or integrated with one or both of the left temple piece 122 and right temple piece 124. The touchpad is generally vertically arranged, approximately parallel to a user's temple in some examples. As used herein, generally vertically aligned means that the touchpad is more vertical than horizontal, although potentially more vertical than that. Additional user input may be provided by one or more buttons, which in the illustrated examples are provided on the outer upper edges of the left optical element holder 104 and right optical element holder 106. The one or more touchpads and buttons provide a means whereby the head-worn AR apparatus 100 can receive input from a user of the head-worn AR apparatus 100.

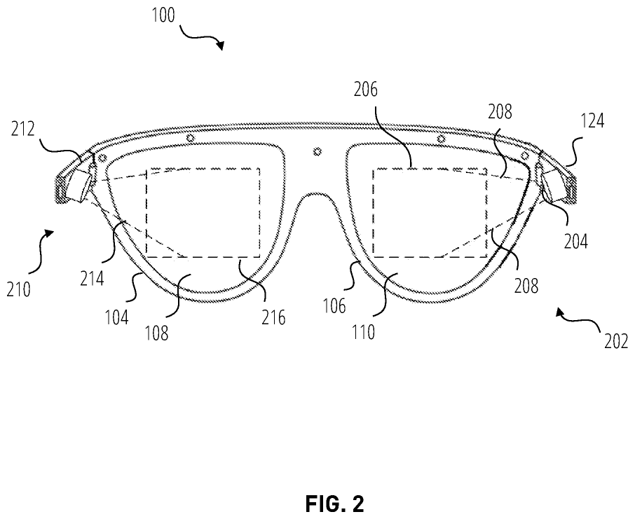

FIG. 2 illustrates the head-worn AR apparatus 100 from the perspective of a user wearing the head-worn AR apparatus 100. For clarity, a number of the elements shown in FIG. 1 have been omitted. As described in FIG. 1, the head-worn AR apparatus 100 shown in FIG. 2 include left optical element 108 and right optical element 110 secured within the left optical element holder 104 and the right optical element holder 106 respectively.

The head-worn AR apparatus 100 includes forward optical assembly 202 comprising a right projector 204 and a right near eye display 206, and a forward optical assembly 210 including a left projector 212 and a left near eye display 216.

In some examples, the right near eye display 206 and left near eye display 216 are waveguides. The waveguides include reflective or diffractive structures (e.g., gratings and/or optical elements such as mirrors, lenses, or prisms). Light 208 emitted by the right projector 204 encounters the diffractive structures of the waveguide of the right near eye display 206, which directs the light towards the right eye of a user to provide an image on or in the right optical element 110 that overlays the view of the real-world scene seen by the user. Similarly, light 214 emitted by the left projector 212 encounters the diffractive structures of the waveguide of the left near eye display 216, which directs the light towards the left eye of a user to provide an image on or in the left optical element 108 that overlays the view of the real-world scene seen by the user. The combination of a GPU, the forward optical assembly 202, the left optical element 108, and the right optical element 110 provide an optical engine of the head-worn AR apparatus 100. The head-worn AR apparatus 100 use the optical engine to generate an overlay of the real-world scene view of the user including display of a user interface to the user of the head-worn AR apparatus 100.

It will be appreciated however that other display technologies or configurations may be utilized within an optical engine to display an image to a user in the user's field of view. For example, instead of a right projector 204 and a waveguide, an LCD, LED or other display panel or surface may be provided.

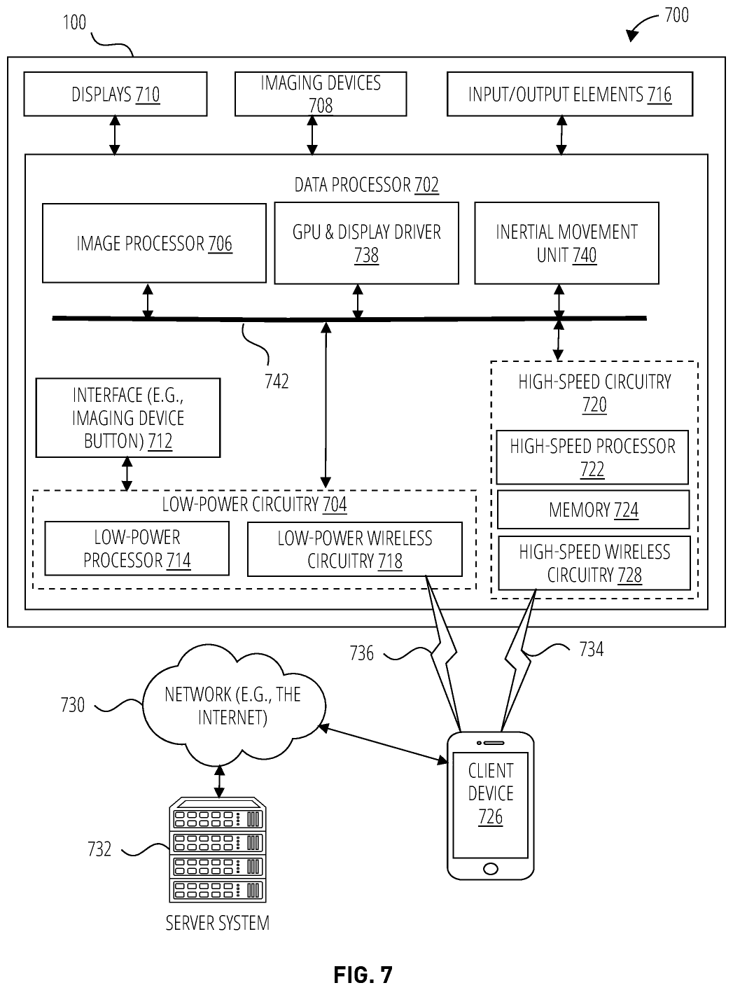

In use, a user of the head-worn AR apparatus 100 will be presented with information, content and various user interfaces on the near eye displays. As described in more detail herein, the user can then interact with the head-worn AR apparatus 100 using a touchpad and/or buttons, voice inputs or touch inputs on an associated device (e.g. client device 726 illustrated in FIG. 7), and/or hand movements, locations, and positions detected by the head-worn AR apparatus 100.

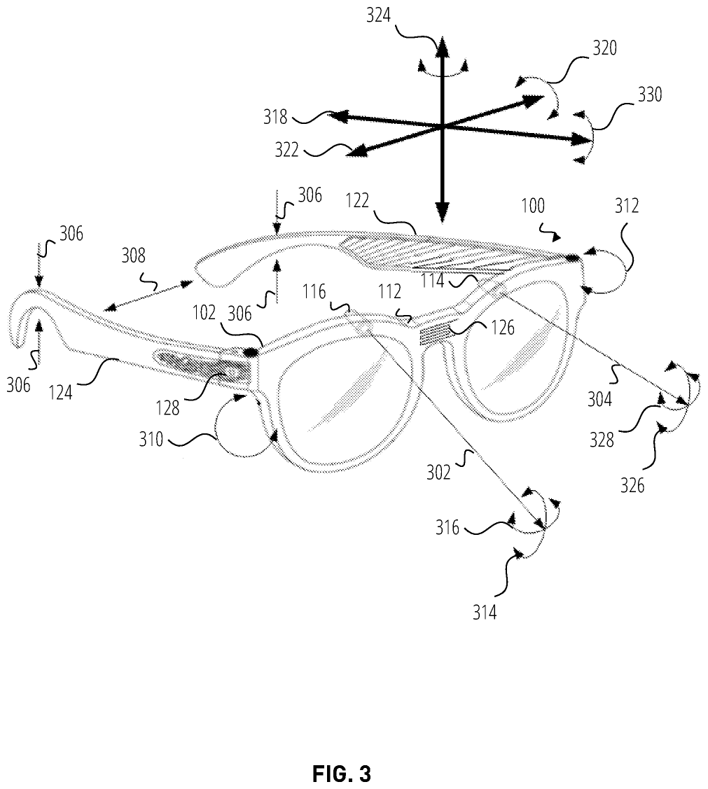

FIG. 3 is an illustration of forces and their effects on a frame of a head-worn AR apparatus, according to some examples. A head-worn AR apparatus 100 includes a frame 102. A forward-facing left imaging device 114 is attached to the frame at a left distal portion and has a left optical axis 304 projecting forward from the left imaging device 114. A forward-facing right imaging device 116 is attached to the frame at a right distal portion and has a right optical axis 302 projecting forward from the right imaging device 116. The frame 102 is attached to a left temple piece 122 and a right temple piece 124.

One or more strain gauges 126 are attached to the frame 102 at a bridge portion 112 of the frame. The one or more strain gauges 126 are operable to measure horizontal or longitudinal strains of the frame 102. In some examples, the one or more strain gauges 126 are configured to measure vertical or latitudinal strains of the frame 102. In some examples, the one or more strain gauges 126 is configured to measure torsional strains of the frame 102. In some examples, one or more of the strain gauges 126 are located on other portions of the frame 102.

The frame 102 includes an Inertial Measurement Unit (IMU) 128 configured to measure a physical orientation or pose of the frame 102. In some examples, the inertial measurement unit 128 is operable to measure a rotation angle of the frame 102 around a pitch rotational axis 322, a roll rotation axis 318, and a yaw rotational axis 324. In some examples, the inertial measurement unit 128 is operable to measure a rotational movement of the frame 102 around a pitch rotational axis 322, a roll rotation axis 318, and a yaw rotational axis 324 as well as translational movement of the frame 102 within a 3D space.

When horizontal forces 308 act upon the right temple piece 124 and left temple piece 122, the frame 102 may experience opposing yaw bending motions, such as right yaw bending motion 310 and left yaw bending motion 312, at distal portions of the frame 102 where the left temple piece 122 and the right temple piece 124 attach to the frame 102. These opposing yaw bending motions may cause yaw bending strains about the yaw rotational axis 324 in the frame 102. The one or more strain gauges 126 are operable to measure the yaw bending strains in the frame 102. The yaw bending strains are used to determine a relative change between a right optical axis yaw angle 316 of the right imaging device 116 and a left optical axis yaw angle 328 of the left imaging device 114.

When unbalanced vertical forces act upon the frame 102, the frame 102 may experience opposing yaw bending motions, such as right yaw bending motion 310 and left yaw bending motion 312, at distal portions of the frame 102 where the left temple piece 122 and the right temple piece 124 attach to the frame 102. These opposing yaw bending motions may cause yaw bending strains about the yaw rotational axis 324 in the frame 102. The one or more strain gauges 126 are operable to measure the yaw bending strains in the frame 102. The yaw bending strains are used to determine a relative change between a right optical axis yaw angle 316 of the right imaging device 116 and a left optical axis yaw angle 328 of the left imaging device 114.

In some examples, torsional strains of the frame 102 may be induced by unbalanced rotational forces acting on portions of the frame 102. These torsional strains may cause roll bending strains in the frame 102 about the roll rotation axis 318. The one or more strain gauges 126 are operable to measure the roll bending strains in the frame 102. The roll bending strains are used to determine a relative change between a right optical axis roll angle of the right imaging device 116 and a left optical axis roll angle of the left imaging device 114.

In some examples, torsional strains of the frame 102 may cause pitch bending strains in the frame 102 about the pitch rotational axis 322. The one or more strain gauges 126 are operable to measure the pitch bending strains in the frame 102. The pitch bending strains are used to determine a relative change between a right optical axis pitch angle of the right imaging device 116 and a left optical axis pitch angle of the left imaging device 114.

In some examples, there are two or more IMUs and each IMU is associated with an imaging device. Roll bending and/or pitch bending of the frame 102 can be estimated based on the differences in roll movement and pitch movement determined by the two or more IMUs.

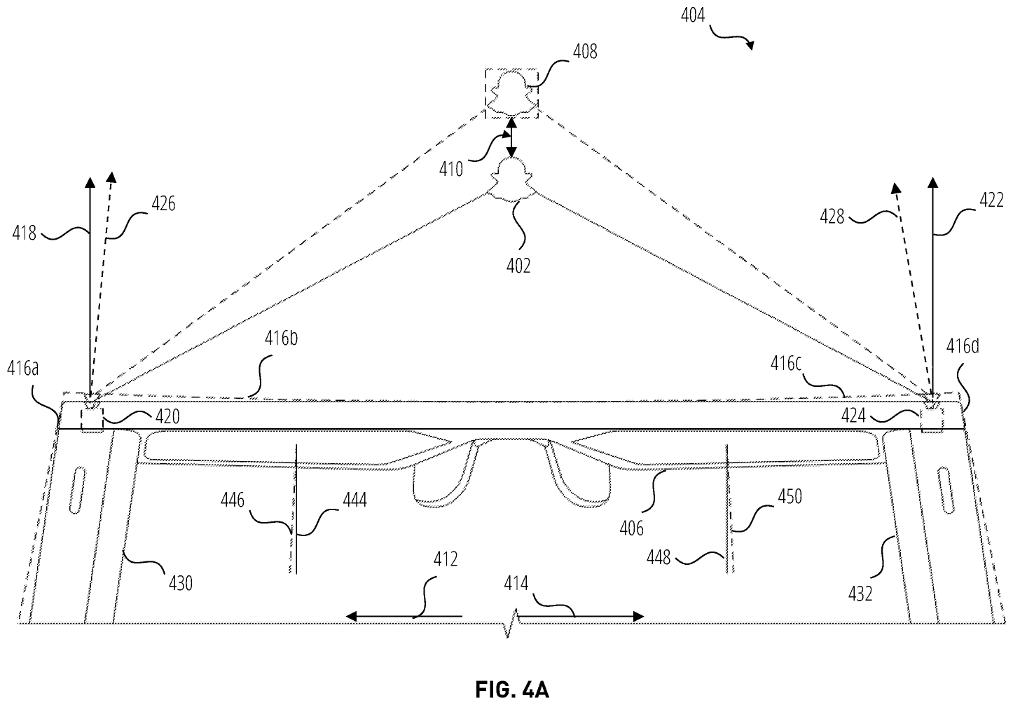

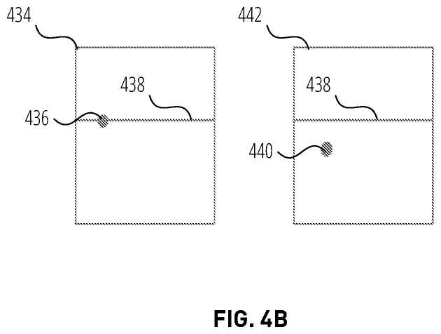

FIG. 4A and FIG. 4B illustrate depth misalignment errors resulting from yaw bending and pitch movement of a head-worn AR system, such as glasses 404, in response of lateral and vertical forces acting on a frame of the head-worn AR system, according to some examples. A head-worn AR system, such as glasses 404, experiences optical misalignment errors caused by a frame 406 of the head-worn AR system deforming or bending when worn by a user. When a user places the head-worn AR system on their head, the temple pieces, such as left temple piece 430 and right temple piece 432, are strained by opposing lateral forces 412 and 414, bending the frame 406 along its length, herein termed “yaw bending”, as indicated by bending lines 416a, 416b, 416c, and 416d. In addition, when the glasses 404 experience a vertical force on one or both of the temple pieces of the glasses 404, the glasses 404 are subject to a pitch movement. The yaw bending and the pitch movement can lead to misalignment errors for the optical components of the AR glasses 404. These misalignment errors can lead to tracking errors when tracking data is generated by the AR system and to misalignment between a virtual overlay being provided to the user by the AR system and physical objects and features of a real-world scene being viewed by the user while wearing the head-worn AR system.

Yaw bending may cause the left imaging device 420 and the right imaging device 424 to experience yaw motions. The yaw motions may cause a left optical axis 418 of the left imaging device 420 to become misaligned, as indicated by misaligned left optical axis 426. The yaw motions may also cause a right optical axis 422 of the right imaging device 424 to become misaligned, as indicated by misaligned right optical axis 428. When video frame data of the imaging devices are used to stereoscopically determine a location of a physical feature 402 in a real-world scene, the system incurs a depth or Z error 410 in a Z axis as the physical feature 402 is determined to be at a different location, and thus appears as an apparent physical feature 408, when the AR system generates tracking data of features in the real-world scene.

In a similar manner, when a virtual object of a virtual overlay of an AR experience is rendered in video frame data and provided to a user of the head-worn AR system, the user will experience a misalignment of the provided virtual object with the real-world scene as indicated by left viewing optical axis misalignment 446 of left viewing optical axis 444 and right viewing optical axis misalignment 450 of right viewing optical 448.

In a correctly aligned video frame 434 of a virtual overlay, an AR system correctly displays a virtual object 436 in alignment with a real-world scene feature 438. A misaligned video frame 442 causes the AR system to display a virtual object 440 in an incorrect location in reference to the real-world scene feature 438.

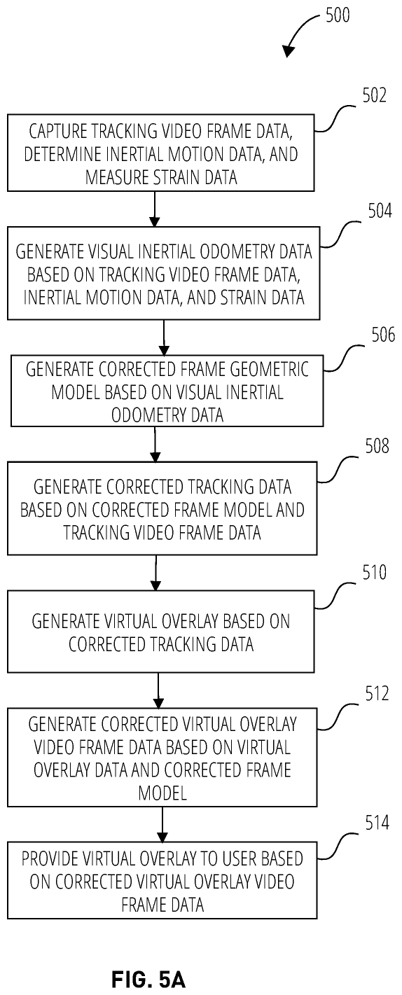

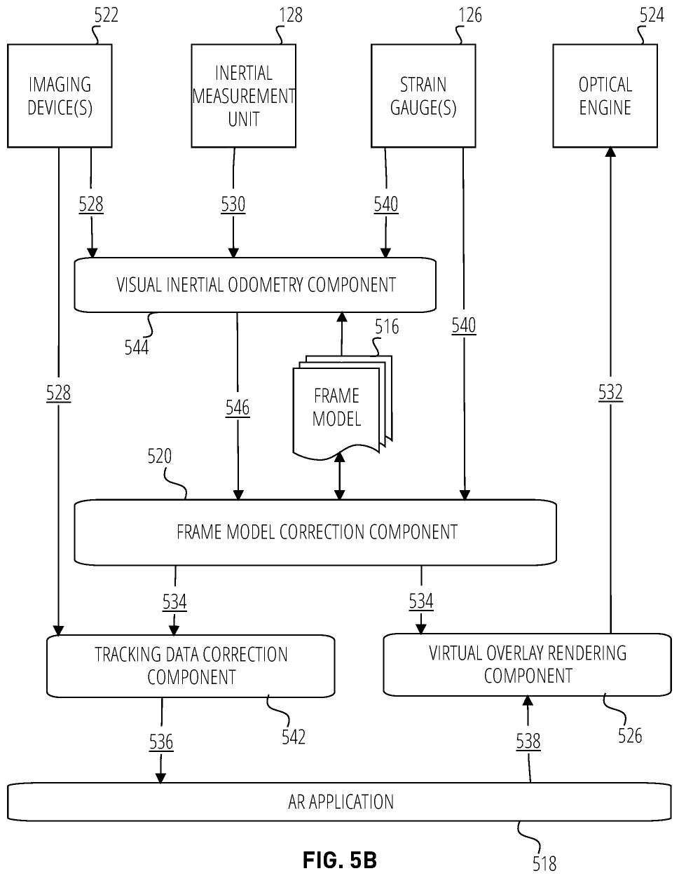

FIG. 5A is a flowchart of a frame bending correction method 500 used by a head-worn AR system, such as head-worn AR apparatus 100, to correct for bending of a frame, such as frame 102, of the head-worn AR system, and FIG. 5B is a collaboration diagram of components of an AR system according to some examples.

In operation 502, the AR system uses one or more imaging devices 522, such as left imaging device 114 and right imaging device 116 of FIG. 1, mounted on the frame 102 of the head-worn AR apparatus 100 to capture tracking video frame data 528 of a real-world scene being viewed by a user of the head-worn AR apparatus 100.

The AR system also uses one or more strain gauges 126 mounted on a bridge portion 112 of the frame 102 to measure strain data 540. The strain data 540 includes a measurement of an amount of yaw strain or yaw bending of the frame 102 as the tracking video frame data 528 is being captured by the one or more imaging devices 522. In some examples, one or more of the strain gauges 126 are mounted on portions of the frame 102 other than the bridge portion 112 of the frame 102 and are operable to measure strains of the frame 102 other than strains on the bridge portion 112 of the frame 102.

In some examples, the one or more strain gauges 126 are operable to measure an amount of pitch strain or pitch bending of the frame 102. In additional examples, the one or more strain gauges 126 are operable to measure a roll strain or roll bending of the frame 102.

In operation 504, the AR system uses a visual inertial odometry component 544 to generate visual inertial odometry data 546 based on the tracking video frame data 528, the strain data 540, and a frame model 516. The frame model 516 includes data of a geometric model of the frame 102 that defines spatial locations and geometric relationships between various components of the frame 102 such as, but not limited to, data of geometric relationships between the one or more imaging devices 522, such as left imaging device 114 and right imaging device 116 of head-worn AR apparatus 100. The frame model 516 also includes data of locations and geometric relationships between components of an optical engine 524, such as a left projector 212 and a left optical element 108 of head-worn AR apparatus 100, and data of locations and geometric relationships between a right projector 204 and a right optical element 110 of head-worn AR apparatus 100. The frame model 516 also includes data of frame flexural rigidity values or stiffness values of the frame 102 at various positions along the frame, such as the flexural rigidity of the frame when yaw bending forces, pitch movement forces, and roll movement forces, act on the frame 102 via the left temple piece 122 and the right temple piece 124 of head-worn AR apparatus 100.

In some examples, the data of the frame model 516, including the frame flexural rigidity values and the frame model, are generated from a finite element analysis of a frame as designed. In some examples, the data of the frame model 516, including the frame flexural rigidity values and the frame model, are determined through testing and calibration of the frame as constructed. In some examples, the data of the frame model 516, including the frame flexural rigidity values and the frame model, are generated from a combination of finite element analysis of the frame as designed and testing and calibration of the frame as constructed.

In some examples, the visual inertial odometry component 544 determines yaw bending data of the frame 102 based on the strain data 540 and a look up table correlating the strain data 540 and an amount of yaw bending of the frame 102. The AR system uses the yaw bending data to determine a corrected frame model indicating the spatial relationships of the one or more imaging devices 522 during the capture of the tracking video frame data 528. The visual inertial odometry component 544 generates visual inertial odometry data 546 based on the tracking video frame data 528 and the corrected frame model by extracting features from successive video frames of the tracking video frame data 528. The AR system identifies one or more extracted features as reference features that are tracked between successive video frames. The AR system determines apparent 3D locations of the reference features in the successive video frames based on the video frame data of the reference features and the spatial relationships and physical locations of the one or more imaging devices 522 as determined by the corrected frame model. By comparing the apparent 3D locations of the reference features in successive video frames, the AR system can determine a physical orientation or pose and physical movement or translation of the frame 102 based on changes in the apparent 3D locations of the reference features between successive video frames of the tracking video frame data 528.

In some examples, the visual inertial odometry component 544 extracts the reference features from the tracking video frame data 528 using computer vision methodologies including, but not limited to, Harris corner detection, Shi-Tomasi corner detection, Scale-Invariant Feature Transform (SIFT), Speeded-Up Robust Features (SURF), Features from Accelerated Segment Test (FAST), Oriented FAST and Rotated BRIEF (ORB), and the like.

In some examples, the AR system determines inertial movement data 530 of the frame 102 using an inertial measurement unit 128 (IMU) mounted to the frame 102 of the head-worn AR apparatus 100. The inertial movement data 530 includes data of a physical orientation or pose of the frame 102 such as, but not limited to, a yaw angle of the frame 102, a pitch angle of the frame 102, and a roll angle of the frame 102, as the one or more imaging devices 522 capture the tracking video frame data 528. In some examples, the inertial movement data 530 includes translation data, such as a yaw movement of the frame 102, a pitch movement of the frame 102, a roll movement of the frame 102, and a spatial translation of the frame 102 as the one or more imaging devices 522 capture the tracking video frame data 528. The AR system generates the visual inertial odometry data 546 based on the inertial movement data 530, the tracking video frame data 528, and the strain data 540. For example, AR system determines seed or initial inertial odometry data based on the inertial movement data 530. The AR system uses the initial inertial odometry data during a subsequent generation of the visual inertial odometry data 546 based on the tracking video frame data 528, the strain data 540, the frame model 516, and the initial inertial odometry data.

In some examples, the visual inertial odometry component 544 generates the visual inertial odometry data 546 on the basis of categorizing the tracking video frame data 528, the inertial movement data 530, and the strain data 540 using artificial intelligence methodologies and a visual inertial odometry model previously generated using machine learning methodologies. In some examples, a visual inertial odometry model comprises, but is not limited to, a neural network, a learning vector quantization network, a logistic regression model, a support vector machine, a random decision forest, a naïve Bayes model, a linear discriminant analysis model, a K-nearest neighbor model, and the like. In some examples, machine learning methodologies may include, but are not limited to, supervised learning, unsupervised learning, semi-supervised learning, reinforcement learning, dimensionality reduction, self-learning, feature learning, sparse dictionary learning, anomaly detection, and the like.

In some examples, the visual inertial odometry component 544 determines the visual inertial odometry data 546 on the basis of categorizing the tracking video frame data 528, the inertial movement data 530, and the strain data 540 using Kalman Filter methodologies.

In operation 506, the AR system uses a frame model correction component 520 to generate corrected frame model data 534 based on the visual inertial odometry data 546 and the frame model 516. For example, the frame model correction component 520 uses physical orientation or pose data and translation data of the frame 102 included in the visual inertial odometry data 546 to determine forces acting upon the frame 102. The frame model correction component 520 uses the forces acting on the frame 102 along with frame flexural rigidity values included in the frame model 516 to calculate strains of the frame 102 as the AR system uses the one or more imaging devices 522 to capture the tracking video frame data 528. The frame model correction component 520 uses the strains of the frame and geometry data of the frame 102 included in the frame model 516 to calculate changes in the spatial relationships between the one or more imaging devices 522 and optical components of the optical engine 524. In some examples, the corrected frame model data 534 includes data of a corrected geometric relationship between the one or more imaging devices 522, such as the left imaging device 114 and right imaging device 116 of head-worn AR apparatus 100 as the frame 102 experiences the measured forces or pressure. The corrected frame model data 534 also includes data of corrected geometric relationships between the left projector 212 and the left optical element 108, and data of a corrected geometric relationship of a right projector 204 and a right optical element 110 of head-worn AR apparatus 100.

In some examples, the frame model correction component 520 generates the corrected frame model data 534 using the strain data 540 received from the one or more strain gauges 126. For example, the frame model correction component 520 generates yaw bending data for the frame 102 based on the strain data 540. The frame model correction component 520 uses the yaw bending data along with the frame model 516 to generate the corrected frame model data 534. In some examples, the amount of yaw bending is determined based on a look up table and the strain data 540.

In operation 508, the AR system uses a tracking data correction component 542 to generate corrected tracking data 536 based on the corrected frame model data 534 and the tracking video frame data 528. The tracking data correction component 542 recognizes the features of physical objects in the tracking video frame data 528 and maps the features into a 3D model of the real-world scene in accordance with a 3D coordinate system, such as a 3D cartesian coordinate system or a 3D polar coordinate system. For example, when two imaging devices are used to capture the tracking video frame data 528, a distance between the imaging devices and an angle of an optical axis of the two imaging devices can be used along with video frame data of a feature of a physical object to determine the 3D coordinates for a location of the object using triangulation. As another example, when one imaging device is used to capture the tracking video frame data 528, the 3D coordinates of the location of a feature can be determined using an angle of an optical axis of the imaging device and an assumed physical size of the feature. The corrected frame model data 534 includes corrected distances between imaging devices mounted on the frame and corrected optical axis angles of the imaging devices. Using the corrected distances and optical axis angles of the imaging devices reduces errors in the determined 3D coordinates of the locations of features recognized in the tracking video frame data 528 by the tracking data correction component 542.

In operation 510, the AR system uses an AR application 518 to generate virtual overlay data 538 using the corrected tracking data 536. The virtual overlay data 538 includes data of virtual objects generated by the AR application 518 that are used to create a virtual overlay that is provided to the user of the AR system using the optical engine 524. The virtual objects are mapped into the 3D model of the real-world scene using the corrected tracking data 536 such that when the virtual objects rendered into video frame data are provided to the user in a display by the optical engine 524, the virtual objects appear to be located in the real-world scene in specified relationships to the features of physical objects recognized in the corrected tracking data 536. For example, a virtual overlay may include a user interface composed of virtual objects that the user interacts with using the user's hands. The virtual objects will appear in the virtual overlay in apparent locations near a location of the user's hands as determined from the corrected tracking data 536 such that the user can reach out and interact with the virtual objects.

In operation 512, the AR system uses a virtual overlay rendering component 526 to generate corrected virtual overlay video frame data 532 using the virtual overlay data 538 and the corrected frame model data 534 by rendering the virtual objects of the virtual overlay into video frame data. The corrected virtual overlay video frame data 532 is provided to the user in a display by the optical engine 524. The optical engine 524 includes projectors, such as left projector 212 and right projector 204 of head-worn AR apparatus 100 to project images of the corrected virtual overlay video frame data 532 onto optical elements, such as left optical element 108 and right optical element 110 of head-worn AR apparatus 100. When forces or pressure act upon the temple pieces and frame of the head-worn AR apparatus 100, misalignments can occur. The virtual overlay rendering component 526 uses the corrected frame model data 534 to correct the video frame data generated by rendering the virtual objects of the virtual overlay data 538 to account for the misalignments between the projectors and the optical elements of head-worn AR apparatus 100.

In operation 514, the AR system uses the optical engine 524 to provide the virtual overlay to the user based on the corrected virtual overlay video frame data 532. For example, one or more projectors of the head-worn AR apparatus 100 project images included in the corrected virtual overlay video frame data 532 on to one more optical elements of head-worn AR apparatus 100 and the user can see the virtual overlay overlaid a real-world scene viewable by the user through the optical elements.

In some examples, the AR system recalibrates the strain gauges 126 based on the strain data 540. For example, a user places the frame 102 of the head-worn AR apparatus 100 into a specified relaxed configuration where a measurement of the output of the strain gauges 126 can be determined on a relaxed or unstressed frame 102. In some examples, the frame 102 can be placed on a flat horizontal surface such as a table top or the like with its respective temple pieces fully opened and not stressed. In this configuration, the strain gauges 126 are relaxed and the strain data 540 is used to re-zero or recalibrate the strain gauges 126. This allows the AR system to recalibrate the strain gauges 126 as they age.

In some examples, the configuration of the head-worn AR apparatus 100 is confirmed based on the tracking video frame data 528. For example, the tracking video frame data 528 can be used to determine that the head-worn AR apparatus 100 is not being worn by a user by detecting that a field of view of the imaging devices 522 includes a flat surface extending from the base of the frame. In some examples, the configuration of the head-worn AR apparatus 100 is confirmed based on the inertial movement data 530. For example, a movement value of the inertial movement data 530 can be compared to a threshold movement value. In response to determining that the movement value does not exceed the threshold movement value, the AR system determines that the head-worn AR apparatus 100 is not being worn by a user.

In some examples, a user places the head-worn AR apparatus 100 into a specified stressed configuration that stresses the frame 102 by a known amount. For example, the user may balance the frame 102 on the user's finger at a bridge portion 112 of the frame 102, thus stressing the bridge portion 112. In some examples, the user may hold the head-worn AR apparatus 100 by one or more of the temple pieces. Strain data 540 collected while the head-worn AR apparatus 100 is held in a stressed configuration is then used to re-calculate a sensitivity or recalibrate the strain gauges 126.

In some examples, the one or more strain gauges 126 are calibrated based on tracking video frame data, inertial movement data, and strain data captured from the head-worn AR apparatus 100 in an unstressed configuration and a stressed configuration as the head-worn AR apparatus 100 captures tracking video frame data 528 of an alignment object. For example, the head-worn AR apparatus 100 captures initial tracking video frame data, initial inertial movement data, and initial strain data while the frame 102 of the head-worn AR apparatus 100 is in a relaxed position at a specified pose and pointed at a specified alignment object such that the initial tracking video frame data captures the alignment object. Without relocating the head-worn AR apparatus 100, the user places the frame 102 into a specified stressed configuration that stresses the frame 102 by a known amount. Stressed tracking video frame data, stressed inertial movement data, and stressed strain data are captured by the head-worn AR apparatus 100 such that the stressed tracking video frame data captures the alignment object. The head-worn AR apparatus 100 recalibrates a sensitivity of the one or more strain gauges 126 based on the initial tracking video frame data, initial inertial movement data, initial strain data, stressed tracking video frame data, stressed inertial movement data, stressed strain data.

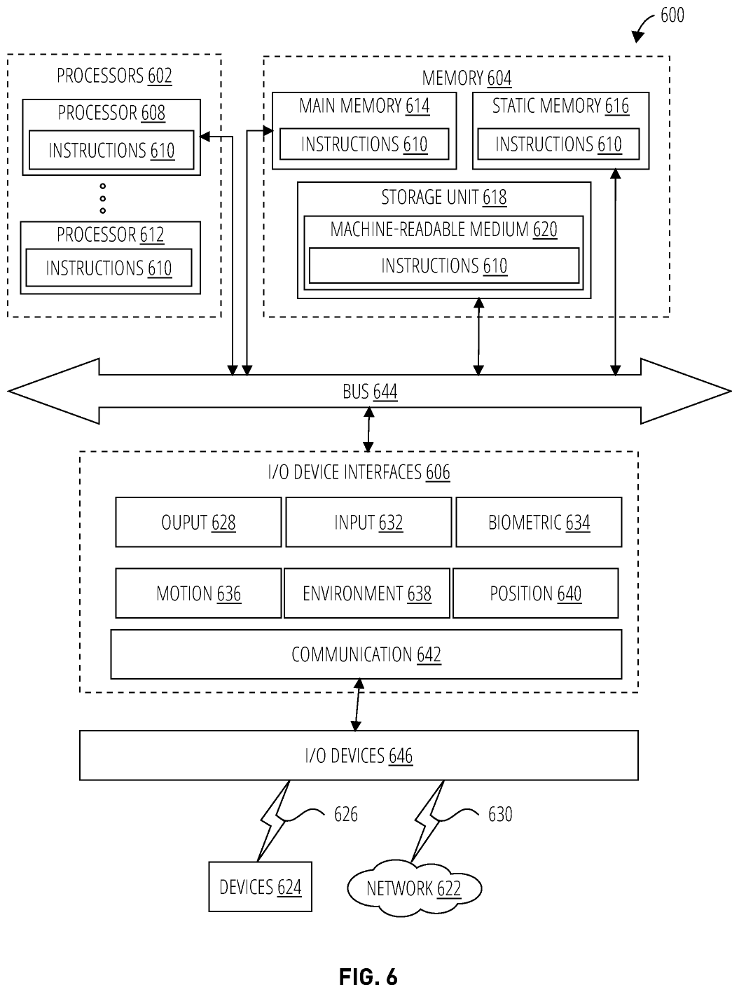

FIG. 6 is a diagrammatic representation of a machine 600 within which instructions 610 (e.g., software, a program, an application, an applet, an app, or other executable code) for causing the machine 600 to perform any one or more of the methodologies discussed herein may be executed. The machine 600 may be utilized as a computer 120 of an AR system such as head-worn AR apparatus 100 of FIG. 1. For example, the instructions 610 may cause the machine 600 to execute any one or more of the methods described herein. The instructions 610 transform the general, non-programmed machine 600 into a particular machine 600 programmed to carry out the described and illustrated functions in the manner described. The machine 600 may operate as a standalone device or may be coupled (e.g., networked) to other machines. In a networked deployment, the machine 600 may operate in the capacity of a server machine or a client machine in a server-client network environment, or as a peer machine in a peer-to-peer (or distributed) network environment. The machine 600 in conjunction with other components of the AR system may function as, but not is not limited to, a server, a client, computer, a personal computer (PC), a tablet computer, a laptop computer, a netbook, a set-top box (STB), a PDA, an entertainment media system, a cellular telephone, a smart phone, a mobile device, a head-worn device (e.g., a smart watch), a smart home device (e.g., a smart appliance), other smart devices, a web appliance, a network router, a network switch, a network bridge, or any machine capable of executing the instructions 610, sequentially or otherwise, that specify actions to be taken by the machine 600. Further, while a single machine 600 is illustrated, the term “machine” may also be taken to include a collection of machines that individually or jointly execute the instructions 610 to perform any one or more of the methodologies discussed herein.

The machine 600 may include processors 602, memory 604, and I/O device interfaces 606, which may be configured to communicate with one another via a bus 644. In an example, the processors 602 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a processor 608 and a processor 612 that execute the instructions 610. The term “processor” is intended to include multi-core processors that may comprise two or more independent processors (sometimes referred to as “cores”) that may execute instructions contemporaneously. Although FIG. 6 shows multiple processors 602, the machine 600 may include a single processor with a single core, a single processor with multiple cores (e.g., a multi-core processor), multiple processors with a single core, multiple processors with multiples cores, or any combination thereof.

The memory 604 includes a main memory 614, a static memory 616, and a storage unit 618, both accessible to the processors 602 via the bus 644. The main memory 604, the static memory 616, and storage unit 618 store the instructions 610 embodying any one or more of the methodologies or functions described herein. The instructions 610 may also reside, completely or partially, within the main memory 614, within the static memory 616, within a non-transitory machine-readable medium 620 within the storage unit 618, within one or more of the processors 602 (e.g., within the processor's cache memory), or any suitable combination thereof, during execution thereof by the machine 600.

The I/O device interfaces 606 couple the machine 600 to I/O devices 646. One or more of the I/O devices 646 may be a component of machine 600 or may be separate devices. The I/O device interfaces 606 may include a wide variety of interfaces to the I/O devices 646 used by the machine 600 to receive input, provide output, produce output, transmit information, exchange information, capture measurements, and so on. The specific I/O device interfaces 606 that are included in a particular machine will depend on the type of machine. It will be appreciated that the I/O device interfaces 606 the I/O devices 646 may include many other components that are not shown in FIG. 6. In various examples, the I/O device interfaces 606 may include output component interfaces 628 and input component interfaces 632. The output component interfaces 628 may include interfaces to visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input component interfaces 632 may include interfaces to alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further examples, the I/O device interfaces 606 may include biometric component interfaces 634, motion component interfaces 636, environmental component interfaces 638, or position component interfaces 640, among a wide array of other component interfaces. For example, the biometric component interfaces 634 may include interfaces to components used to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion component interfaces 636 may include interfaces to IMUs, acceleration sensor components (e.g., an accelerometer), gravitation sensor components, rotation sensor components (e.g., a gyroscope), and so forth. The environmental component interfaces 638 may include, for example, interfaces to illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals associated to a surrounding physical environment. The position component interfaces 640 include interfaces to location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O device interfaces 606 further include communication component interfaces 642 operable to couple the machine 600 to a network 622 or devices 624 via a coupling 630 and a coupling 626, respectively. For example, the communication component interfaces 642 may include an interface to a network interface component or another suitable device to interface with the network 622. In further examples, the communication component interfaces 642 may include interfaces to wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 624 may be another machine or any of a wide variety of peripheral devices (e.g., a peripheral device coupled via a USB).

Moreover, the communication component interfaces 642 may include interfaces to components operable to detect identifiers. For example, the communication component interfaces 642 may include interfaces to Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication component interfaces 642, such as location via Internet Protocol (IP) geolocation, location via Wi-Fi® signal triangulation, location via detecting an NFC beacon signal that may indicate a particular location, and so forth.

The various memories (e.g., memory 604, main memory 614, static memory 616, and/or memory of the processors 602) and/or storage unit 618 may store one or more sets of instructions and data structures (e.g., software) embodying or used by any one or more of the methodologies or functions described herein. These instructions (e.g., the instructions 610), when executed by processors 602, cause various operations to implement the disclosed examples.

The instructions 610 may be transmitted or received over the network 622, using a transmission medium, via a network interface device (e.g., a network interface component included in the communication component interfaces 642) and using any one of a number of well-known transfer protocols (e.g., hypertext transfer protocol (HTTP)). Similarly, the instructions 610 may be transmitted or received using a transmission medium via the coupling 626 (e.g., a peer-to-peer coupling) to the devices 624.

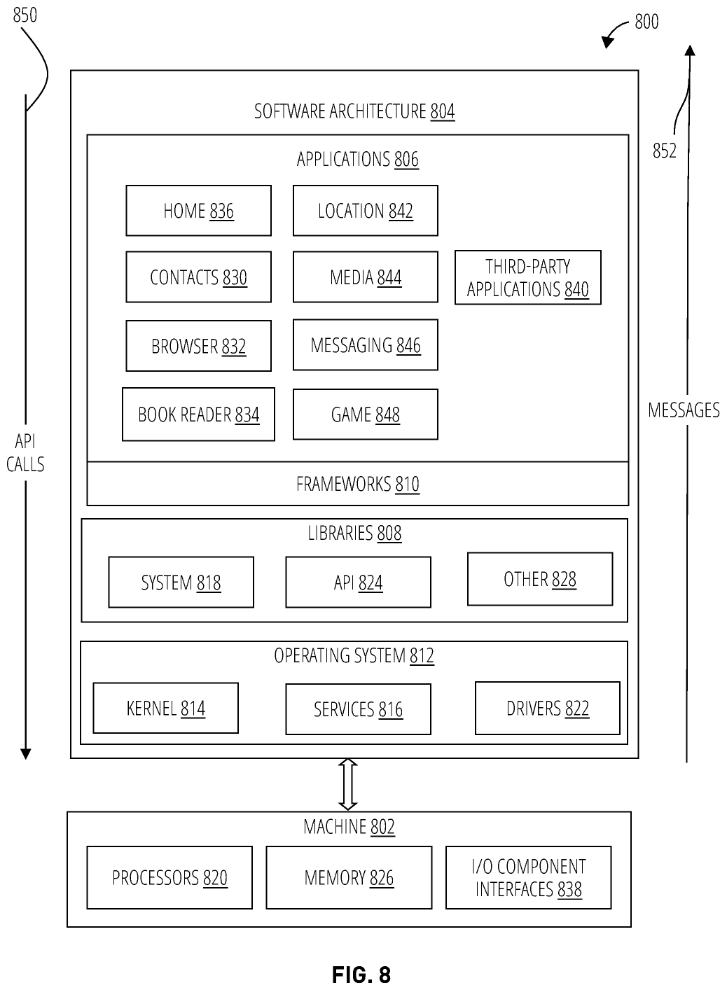

FIG. 7 is a block diagram illustrating a networked system 700 including details of the head-worn AR apparatus 100, in accordance with some examples. The networked system 700 includes the head-worn AR apparatus 100, a client device 726, and a server system 732. The client device 726 may be a smartphone, tablet, phablet, laptop computer, access point, or any other such device capable of connecting with the head-worn AR apparatus 100 using a low-power wireless connection 736 and/or a high-speed wireless connection 734. The client device 726 is connected to the server system 732 via the network 730. The network 730 may include any combination of wired and wireless connections. The server system 732 may be one or more computing devices as part of a service or network computing system. The client device 726 and any elements of the server system 732 and network 730 may be implemented using details of the software architecture 804 or the machine 600 described in FIG. 8 and FIG. 6 respectively.

The head-worn AR apparatus 100 include a data processor 702, displays 710, one or more imaging devices 708, and additional input/output elements 716. The input/output elements 716 may include microphones, audio speakers, biometric sensors, additional sensors, pressure or force sensors, or additional display elements integrated with the data processor 702. Examples of the input/output elements 716 are discussed further with respect to FIG. 8 and FIG. 6. For example, the input/output elements 716 may include any of I/O device interfaces 606 including output component interfaces 628, motion component interfaces 636, and so forth. Examples of the displays 710 are discussed in FIG. 2. In the particular examples described herein, the displays 710 include a display for the user's left and right eyes.

The data processor 702 includes an image processor 706 (e.g., a video processor), a GPU & display driver 738, an inertial movement unit 740, an interface 712, low-power circuitry 704, and high-speed circuitry 720. The components of the data processor 702 are interconnected by a bus 742.

The interface 712 refers to any source of a user command that is provided to the data processor 702. In one or more examples, the interface 712 is a physical button that, when depressed, sends a user input signal from the interface 712 to a low-power processor 714. A depression of such button followed by an immediate release may be processed by the low-power processor 714 as a request to capture a single image, or vice versa. A depression of such a button for a first period of time may be processed by the low-power processor 714 as a request to capture video data while the button is depressed, and to cease video capture when the button is released, with the video captured while the button was depressed stored as a single video file. Alternatively, depression of a button for an extended period of time may capture a still image. In some examples, the interface 712 may be any mechanical switch or physical interface capable of accepting user inputs associated with a request for data from the imaging devices 708. In other examples, the interface 712 may have a software component, or may be associated with a command received wirelessly from another source, such as from the client device 726.

The image processor 706 includes circuitry to receive signals from the imaging devices 708 and process those signals from the imaging devices 708 into a format suitable for storage in the memory 724 or for transmission to the client device 726. In one or more examples, the image processor 706 (e.g., video processor) comprises a microprocessor integrated circuit (IC) customized for processing sensor data from the imaging devices 708, along with volatile memory used by the microprocessor in operation.

The low-power circuitry 704 includes the low-power processor 714 and the low-power wireless circuitry 718. These elements of the low-power circuitry 704 may be implemented as separate elements or may be implemented on a single IC as part of a system on a single chip. The low-power processor 714 includes logic for managing the other elements of the head-worn AR apparatus 100. As described above, for example, the low-power processor 714 may accept user input signals from the interface 712. The low-power processor 714 may also be configured to receive input signals or instruction communications from the client device 726 via the low-power wireless connection 736. The low-power wireless circuitry 718 includes circuit elements for implementing a low-power wireless communication system. Bluetooth™ Smart, also known as Bluetooth™ low energy, is one standard implementation of a low power wireless communication system that may be used to implement the low-power wireless circuitry 718. In other examples, other low power communication systems may be used.

The high-speed circuitry 720 includes a high-speed processor 722, a memory 724, and a high-speed wireless circuitry 728. The high-speed processor 722 may be any processor capable of managing high-speed communications and operation of any general computing system used for the data processor 702. The high-speed processor 722 includes processing resources used for managing high-speed data transfers on the high-speed wireless connection 734 using the high-speed wireless circuitry 728. In some examples, the high-speed processor 722 executes an operating system such as a LINUX operating system or other such operating system such as the operating system 812 of FIG. 8. In addition to any other responsibilities, the high-speed processor 722 executing a software architecture for the data processor 702 is used to manage data transfers with the high-speed wireless circuitry 728. In some examples, the high-speed wireless circuitry 728 is configured to implement Institute of Electrical and Electronic Engineers (IEEE) 802.11 communication standards, also referred to herein as Wi-Fi. In other examples, other high-speed communications standards may be implemented by the high-speed wireless circuitry 728.

The memory 724 includes any storage device capable of storing imaging device data generated by the imaging devices 708 and the image processor 706. While the memory 724 is shown as integrated with the high-speed circuitry 720, in other examples, the memory 724 may be an independent standalone element of the data processor 702. In some such examples, electrical routing lines may provide a connection through a chip that includes the high-speed processor 722 from image processor 706 or the low-power processor 714 to the memory 724. In other examples, the high-speed processor 722 may manage addressing of the memory 724 such that the low-power processor 714 will boot the high-speed processor 722 any time that a read or write operation involving the memory 724 is desired.

The inertial movement unit 740 estimates a physical orientation or pose of the head-worn AR apparatus 100. For example, the inertial movement unit 740 uses image data from the imaging devices 708 and associated inertial data determined using the position component interfaces 640, as well as GPS data, to track a location and determine a pose of the head-worn AR apparatus 100 relative to a frame of reference (e.g., real-world scene). The inertial movement unit 740 continually gathers and uses updated sensor data describing movements of the head-worn AR apparatus 100 to determine updated three-dimensional poses of the head-worn AR apparatus 100 that indicate changes in the relative position and orientation relative to physical objects in the real-world scene. The inertial movement unit 740 permits visual placement of virtual objects relative to physical objects by the head-worn AR apparatus 100 within the field of view of the user via the displays 710.

The GPU & display driver 738 may use the pose of the head-worn AR apparatus 100 to generate frames of virtual content or other content to be presented on the displays 710 when the head-worn AR apparatus 100 are functioning in a traditional augmented reality mode. In this mode, the GPU & display driver 738 generates updated frames of virtual content based on updated three-dimensional poses of the head-worn AR apparatus 100, which reflect changes in the position and orientation of the user in relation to physical objects in the user's view of the real-world scene.

One or more functions or operations described herein may also be performed in an application resident on the head-worn AR apparatus 100 or on the client device 726, or on a remote server. For example, one or more functions or operations described herein may be performed by one of the applications 806 such as messaging application 846.

FIG. 8 is a block diagram 800 illustrating a software architecture 804, which can be installed on any one or more of the devices described herein. The software architecture 804 is supported by hardware such as a machine 802 that includes processors 820, memory 826, and I/O component interfaces 838. In this example, the software architecture 804 can be conceptualized as a stack of layers, where individual layers provide a particular functionality. The software architecture 804 includes layers such as an operating system 812, libraries 808, frameworks 810, and applications 806. Operationally, the applications 806 invoke API calls 850 through the software stack and receive messages 852 in response to the API calls 850.

The operating system 812 manages hardware resources and provides common services. The operating system 812 includes, for example, a kernel 814, services 816, and drivers 822. The kernel 814 acts as an abstraction layer between the hardware and the other software layers. For example, the kernel 814 provides memory management, processor management (e.g., scheduling), component management, networking, and security settings, among other functionalities. The services 816 can provide other common services for the other software layers. The drivers 822 are responsible for controlling or interfacing with the underlying hardware. For instance, the drivers 822 can include display drivers, imaging device drivers, BLUETOOTH® or BLUETOOTH® Low Energy drivers, flash memory drivers, serial communication drivers (e.g., Universal Serial Bus (USB) drivers), WI-FI® drivers, audio drivers, power management drivers, and so forth.

The libraries 808 provide a low-level common infrastructure used by the applications 806. The libraries 808 can include system libraries 818 (e.g., C standard library) that provide functions such as memory allocation functions, string manipulation functions, mathematic functions, and the like. In addition, the libraries 808 can include API libraries 824 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) graphic content on a display, GLMotif used to implement user interfaces), image feature extraction libraries (e.g. OpenIMAJ), database libraries (e.g., SQLite to provide various relational database functions), web libraries (e.g., WebKit to provide web browsing functionality), and the like. The libraries 808 can also include a wide variety of other libraries 828 to provide many other APIs to the applications 806.

The frameworks 810 provide a high-level common infrastructure that is used by the applications 806. For example, the frameworks 810 provide various graphical user interface (GUI) functions, high-level resource management, and high-level location services. The frameworks 810 can provide a broad spectrum of other APIs that can be used by the applications 806, some of which may be specific to a particular operating system or platform.

In an example, the applications 806 may include a home application 836, a contacts application 830, a browser application 832, a book reader application 834, a location application 842, a media application 844, a messaging application 846, a game application 848, and a broad assortment of other applications such as third-party applications 840. The applications 806 are programs that execute functions defined in the programs. Various programming languages can be employed to create one or more of the applications 806, structured in a variety of manners, such as object-oriented programming languages (e.g., Objective-C, Java, or C++) or procedural programming languages (e.g., C or assembly language). In a specific example, the third-party applications 840 (e.g., applications developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party applications 840 can invoke the API calls 850 provided by the operating system 812 to facilitate functionality described herein.

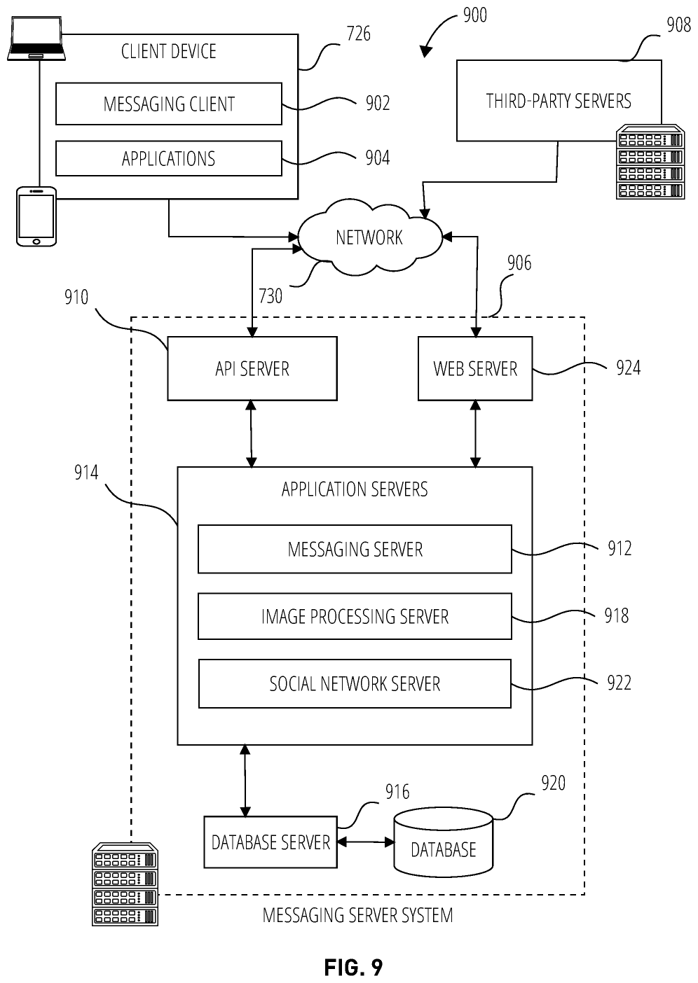

FIG. 9 is a block diagram showing an example messaging system 900 for exchanging data (e.g., messages and associated content) over a network. The messaging system 900 includes multiple instances of a client device 726 which host a number of applications, including a messaging client 902 and other applications 904. A messaging client 902 is communicatively coupled to other instances of the messaging client 902 (e.g., hosted on respective other client devices 726), a messaging server system 906 and third-party servers 908 via a network 730 (e.g., the Internet). A messaging client 902 can also communicate with locally hosted applications 904 using Application Program Interfaces (APIs).

A messaging client 902 is able to communicate and exchange data with other messaging clients 902 and with the messaging server system 906 via the network 730. The data exchanged between messaging clients 902, and between a messaging client 902 and the messaging server system 906, includes functions (e.g., commands to invoke functions) as well as payload data (e.g., text, audio, video or other multimedia data).

The messaging server system 906 provides server-side functionality via the network 730 to a particular messaging client 902. While some functions of the messaging system 900 are described herein as being performed by either a messaging client 902 or by the messaging server system 906, the location of some functionality either within the messaging client 902 or the messaging server system 906 may be a design choice. For example, it may be technically preferable to initially deploy some technology and functionality within the messaging server system 906 but to later migrate this technology and functionality to the messaging client 902 where a client device 726 has sufficient processing capacity.

The messaging server system 906 supports various services and operations that are provided to the messaging client 902. Such operations include transmitting data to, receiving data from, and processing data generated by the messaging client 902. This data may include message content, client device information, geolocation information, media augmentation and overlays, message content persistence conditions, social network information, and live event information, as examples. Data exchanges within the messaging system 900 are invoked and controlled through functions available via user interfaces (UIs) of the messaging client 902.

Turning now specifically to the messaging server system 906, an Application Program Interface (API) server 910 is coupled to, and provides a programmatic interface to, application servers 914. The application servers 914 are communicatively coupled to a database server 916, which facilitates access to a database 920 that stores data associated with messages processed by the application servers 914. Similarly, a web server 924 is coupled to the application servers 914, and provides web-based interfaces to the application servers 914. To this end, the web server 924 processes incoming network requests over the Hypertext Transfer Protocol (HTTP) and several other related protocols.

The Application Program Interface (API) server 910 receives and transmits message data (e.g., commands and message payloads) between the client device 726 and the application servers 914. Specifically, the Application Program Interface (API) server 910 provides a set of interfaces (e.g., routines and protocols) that can be called or queried by the messaging client 902 in order to invoke functionality of the application servers 914. The Application Program Interface (API) server 910 exposes various functions supported by the application servers 914, including account registration, login functionality, the sending of messages, via the application servers 914, from a particular messaging client 902 to another messaging client 902, the sending of media files (e.g., images or video) from a messaging client 902 to a messaging server 912, and for possible access by another messaging client 902, the settings of a collection of media data (e.g., story), the retrieval of a list of friends of a user of a client device 726, the retrieval of such collections, the retrieval of messages and content, the addition and deletion of entities (e.g., friends) to an entity graph (e.g., a social graph), the location of friends within a social graph, and opening an application event (e.g., relating to the messaging client 902).

The application servers 914 host a number of server applications and subsystems, including for example a messaging server 912, an image processing server 918, and a social network server 922. The messaging server 912 implements a number of message processing technologies and functions, particularly related to the aggregation and other processing of content (e.g., textual and multimedia content) included in messages received from multiple instances of the messaging client 902. As will be described in further detail, the text and media content from multiple sources may be aggregated into collections of content (e.g., called stories or galleries). These collections are then made available to the messaging client 902. Other processor and memory intensive processing of data may also be performed server-side by the messaging server 912, in view of the hardware requirements for such processing.

The application servers 914 also include an image processing server 918 that is dedicated to performing various image processing operations, typically with respect to images or video within the payload of a message sent from or received at the messaging server 912.

The social network server 922 supports various social networking functions and services and makes these functions and services available to the messaging server 912. To this end, the social network server 922 maintains and accesses an entity graph within the database 920. Examples of functions and services supported by the social network server 922 include the identification of other users of the messaging system 900 with which a particular user has relationships or is “following,” and also the identification of other entities and interests of a particular user.

The messaging client 902 can notify a user of the client device 726, or other users related to such a user (e.g., “friends”), of activity taking place in shared or shareable sessions. For example, the messaging client 902 can provide participants in a conversation (e.g., a chat session) in the messaging client 902 with notifications relating to the current or recent use of a game by one or more members of a group of users. One or more users can be invited to join in an active session or to launch a new session. In some examples, shared sessions can provide a shared augmented reality experience in which multiple people can collaborate or participate.

A “carrier signal” refers to any intangible medium that is capable of storing, encoding, or carrying instructions for execution by the machine, and includes digital or analog communications signals or other intangible media to facilitate communication of such instructions. Instructions may be transmitted or received over a network using a transmission medium via a network interface device.

A “client device” refers to any machine that interfaces to a communications network to obtain resources from one or more server systems or other client devices. A client device may be, but is not limited to, a mobile phone, desktop computer, laptop, portable digital assistants (PDAs), smartphones, tablets, ultrabooks, netbooks, laptops, multi-processor systems, microprocessor-based or programmable consumer electronics, game consoles, set-top boxes, or any other communication device that a user may use to access a network.

A “communication network” refers to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network and the coupling may be a Code Division Multiple Access (CDMA) connection, a Global System for Mobile communications (GSM) connection, or other types of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long-range protocols, or other data transfer technology.

A “machine-readable medium” refers to both machine-storage media and transmission media. Thus, the terms include both storage devices/media and carrier waves/modulated data signals. The terms “machine-readable medium,” “machine-readable medium” and “device-readable medium” mean the same thing and may be used interchangeably in this disclosure.

A “machine-storage medium” refers to a single or multiple storage devices and/or media (e.g., a centralized or distributed database, and/or associated caches and servers) that store executable instructions, routines and/or data. The term includes, but not be limited to, solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks The terms “machine-storage medium,” “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media, at some of which are covered under the term “signal medium.”

A “processor” refers to any circuit or virtual circuit (a physical circuit emulated by logic executing on an actual processor) that manipulates data values according to control signals (e.g., “commands”, “op codes”, “machine code”, and so forth) and which produces associated output signals that are applied to operate a machine. A processor may, for example, be a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC) or any combination thereof. A processor may further be a multi-core processor having two or more independent processors (sometimes referred to as “cores”) that may execute instructions contemporaneously.

A “signal medium” refers to any intangible medium that is capable of storing, encoding, or carrying the instructions for execution by a machine and includes digital or analog communications signals or other intangible media to facilitate communication of software or data. The term “signal medium” may be taken to include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and may be used interchangeably in this disclosure.

Changes and modifications may be made to the disclosed examples without departing from the scope of the present disclosure. These and other changes or modifications are intended to be included within the scope of the present disclosure, as expressed in the following claims.

What is claimed is:

1. A computer-implemented method, comprising:
capturing, by one or more processors, using one or more imaging devices of an Augmented Reality (AR) system, tracking video frame data of a real-world scene;
measuring, by one or more processors, using one or more strain gauges of the AR system, strain data of strains of a frame of the AR system as the tracking video frame data is captured;
generating, by the one or more processors, a corrected frame model of the frame based on the strain data, the tracking video frame data, and a frame model of the frame; and
generating, by the one or more processors, corrected tracking data based on the corrected frame model and the tracking video frame data.

2. The computer-implemented method of claim 1, further comprising:
generating, by the one or more processors, virtual overlay data based on the corrected tracking data;
generating, by the one or more processors, corrected virtual overlay video frame data based on the corrected frame model and the virtual overlay data; and
providing, by the one or more processors, using an optical engine of the AR system, a virtual overlay to a user of the AR system based on the corrected virtual overlay video frame data.

3. The computer-implemented method of claim 1, wherein the operation of generating the corrected frame model of the frame further comprises:
generating visual inertial odometry data based on the tracking video frame data, the strain data, and the frame model; and
generating the corrected frame model based on the visual inertial odometry data and the frame model.

4. The computer-implemented method of claim 3, wherein the operation of generating the visual inertial odometry data further comprises:
generating yaw bending data of the frame based on the strain data; and
generating the visual inertial odometry data based on the tracking video frame data, the yaw bending data, and the frame model.

5. The computer-implemented method of claim 3, wherein the operation of generating the visual inertial odometry data further comprises:
measuring, by the one or more processors, using an inertial measurement unit of the frame, inertial movement data of the frame as the tracking video frame data is captured;
generating initial inertial odometry data based on the inertial movement data; and
generating the visual inertial odometry data based on the initial inertial odometry data, the tracking video frame data, the strain data, and the frame model of the frame.

6. The computer-implemented method of claim 1, wherein at least one of the one or more strain gauges are mounted on a bridge portion of the frame.

7. The computer-implemented method of claim 1, wherein the AR system comprises a head-worn AR apparatus.

8. An AR system comprising:
a frame;
one or more strain gauges operable to measure strains of the frame;
one or more imaging devices mounted to the frame;
one or more processors; and
a memory storing instructions that, when executed by the one or more processors, cause the AR system to perform operations comprising:
capturing, using the one or more imaging devices, tracking video frame data of a real-world scene;
measuring, by one or more processors, using the one or more strain gauges of the AR system, strain data of the strains of the frame of the AR system as the tracking video frame data is captured;
generating, by the one or more processors, a corrected frame model of the frame based on the strain data, the tracking video frame data, and a frame model of the frame; and
generating, by the one or more processors, corrected tracking data based on the corrected frame model and the tracking video frame data.

9. The AR system of claim 8, wherein the AR system further comprises an optical engine mounted to the frame, and
wherein the instructions when executed by the one or more processors further cause the AR system to perform operations comprising:
generating virtual overlay data based on the corrected tracking data;
generating corrected virtual overlay video frame data based on the corrected frame model and the virtual overlay data; and
providing, using the optical engine, a virtual overlay to a user of the AR system based on the corrected virtual overlay video frame data.

10. The AR system of claim 8, wherein the instructions that, when executed by the one or more processors, cause the AR system to perform operations of generating the corrected frame model of the frame further cause the AR system to perform operations comprising:
generating visual inertial odometry data based on the tracking video frame data, the strain data, and the frame model; and
generating the corrected frame model based on the visual inertial odometry data and the frame model.

11. The AR system of claim 10, wherein the instructions that, when executed by the one or more processors, cause the AR system to perform operations of generating the visual inertial odometry data further cause the AR system to perform operations comprising:
generating yaw bending data of the frame based on the strain data; and
generating the visual inertial odometry data based on the tracking video frame data, the yaw bending data, and the frame model.

12. The AR system of claim 11, wherein the instructions that, when executed by the one or more processors, cause the AR system to perform operations comprising generating the visual inertial odometry data further cause the AR system to perform operations comprising:
determining, by the one or more processors, using an inertial measurement unit of the frame, inertial movement data of the frame as the tracking video frame data is captured;
generating initial inertial odometry data based on the inertial movement data; and
generating the visual inertial odometry data based on the initial inertial odometry data, the tracking video frame data, the strain data, and the frame model of the frame.

13. The AR system of claim 8, wherein at least one of the one or more strain gauges are mounted on a bridge portion of the frame.

14. The AR system of claim 8, wherein the AR system comprises a head-worn AR apparatus.

15. A non-transitory computer-readable storage medium, the computer-readable storage medium including instructions that when executed by a computer, cause the computer to perform operations comprising:
capturing, using one or more imaging devices of an AR system, tracking video frame data of a real-world scene;
measuring, by one or more processors, using one or more strain gauges of the AR system, strain data of strains of a frame of the AR system as the tracking video frame data is captured;
generating, by the one or more processors, a corrected frame model of the frame based on the strain data, the tracking video frame data, and a frame model of the frame; and
generating, by the one or more processors, corrected tracking data based on the corrected frame model and the tracking video frame data.

16. The non-transitory computer-readable storage medium of claim 15, wherein the instructions when executed by the computer further cause the computer to perform operations comprising:
generating virtual overlay data based on the corrected tracking data;
generating corrected virtual overlay video frame data based on the corrected frame model and the virtual overlay data; and
providing, using an optical engine of the AR system, a virtual overlay to a user of the AR system based on the corrected virtual overlay video frame data.

17. The non-transitory computer-readable storage medium of claim 15, wherein the instructions that, when executed by the computer, cause the computer to perform operations of generating the corrected frame model of the frame further cause the computer to perform operations comprising:
generating visual inertial odometry data based on the tracking video frame data, the strain data, and the frame model; and
generating the corrected frame model based on the visual inertial odometry data and the frame model.

18. The non-transitory computer-readable storage medium of claim 17, wherein the instructions that, when executed by the computer, cause the computer to perform operations of generating the visual inertial odometry data further cause the computer to perform operations comprising:
generating yaw bending data of the frame based on the strain data; and
generating the visual inertial odometry data based on the tracking video frame data, the yaw bending data, and the frame model.

19. The non-transitory computer-readable storage medium of claim 18, wherein the instructions that, when executed by the computer, cause the computer to perform operations comprising generating the visual inertial odometry data further cause the computer to perform operations comprising:
determining, using an inertial measurement unit of the frame, inertial movement data of the frame as the tracking video frame data is captured;
generating initial inertial odometry data based on the inertial movement data; and
generating the visual inertial odometry data based on the initial inertial odometry data, the tracking video frame data, the strain data, and the frame model of the frame.

20. The non-transitory computer-readable storage medium of claim 15, wherein the AR system comprises a head-worn AR apparatus.
